(19) United States
(12) Patent Application Publication
(10) Pub. No.: US 2020/0240825 A1
(43) Pub. Date: Jul. 30, 2020

(54) NON-METALLIC LIQUID LEVEL SENSOR ELECTRODE

(71) Applicant: Abertax Research & Development Ltd., Paola (MT)

(72) Inventors: Klaus-Dieter Merz, Büdingen (DE); Joseph Cilia, Haz-Zebbug (MT); Aaron Farrugia, Bubaqra (MT); George Schembri, Birkirkara (MT); Andrea Brincat, Il-Mosta (MT); Noel Ellul, Naxxar (MT); Carmel Ellul, Attard (MT)

(73) Assignee: Abertax Research & Development Ltd., Paola (MT)

(21) Appl. No.: 16/751,111

(22) Filed: Jan. 23, 2020

(30) Foreign Application Priority Data
Jan. 25, 2019 (DE) 102019101940.0

(51) Int. Cl. G01F 23/22; G01F 23/00

(52) U.S. Cl. CPC G01F 23/22; G01F 23/0015

(57) ABSTRACT

An electrode for a liquid level sensor adapted for a determination of a liquid level of an electrically conductive liquid in a container is disclosed. The electrode comprises a first end configured for an electrically conductive contact with a sensor component of the liquid level sensor and a second end opposite the first end. The electrode is formed of one or more non-metallic materials of which at least one is an electrically conductive non-metal that is in electrically conductive contact with the first end of the electrode, wherein the at least one electrically conductive non-metal is configured for an electrically conductive contact with the electrically conductive liquid.

### RELATED APPLICATION

This application claims priority to German Application No. DE 10 2019 101 940.0, the contents of which are herein incorporated by reference in their entirety for all purposes.

### FIELD

The present invention generally relates to an electrode for a liquid level sensor, especially a contact type liquid level sensor, and in particular to a non-metallic electrode for such a sensor.

### BACKGROUND

Liquid level sensors are frequently used when the filling level of a liquid in a container needs to be determined or controlled. There are two basic types of liquid level sensors, contacting sensors having a component in contact with the liquid to be measured and non-contacting sensors where no sensor component is in contact with the liquid to be measured.

For non-continuous point level detection, contacting liquid level sensors are preferably used, whereby the tip of an electrode of the sensor contacts the surface of an electrically conductive liquid or is immersed in the liquid to establish an electrically conductive contact between the electrode and the liquid when the liquid level corresponds to the limit level or is higher.

Point level liquid level sensors usually operate in switching mode producing a first output signal upon an electrical conductive contact being established between the sensor electrode and the liquid and a different second output signal upon the electrical conductive contact between the sensor electrode and the liquid being broken. The sensor's electrode may be part of an electrical circuit that is closed when the electrode is in contact with the liquid and opened when the contact between the electrode and the liquid is broken. In other sensor arrangements, the electrode forms part of a capacitor whose capacitance changes significantly when the electrode contacts the liquid.

Both types of sensor arrangements require the electrode to be electrically conductive or conductible. One of the problems with the use of metallic sensor electrodes in corrosive environments is their often insufficient chemical resistance. In lead-acid batteries with a sulfuric acid electrolyte, for example, lead is usually used as material for the probing sensor electrode because the lead is relatively cheap, easy to cut to the appropriate length and introduces no harmful contaminants into the electrolyte. The potential difference to at least one of the lead plates results in corrosion of the probing electrode and hence in a reduction of its service life.

Furthermore, the use of lead in electrical and electronic equipment is increasingly restricted by legislative measures such as the RoHS Directives of the European Union (2002/95/EG and 2011/65/EU, 2017/2102/EU).

Accordingly, there is a demand for a lead-free chemical resistant electrode for contact type liquid level sensors that are used in corrosive environments and in particular in lead-acid batteries.

### SUMMARY

The invention is achieved as set out in the appended independent claims. Additional advantageous embodiments of the present invention are the subject of dependent claims.

An electrode for a liquid level sensor adapted for a determination of a liquid level of an electrically conductive liquid in a container meeting the above demand comprises a first end, configured for an electrically conductive contact with a sensor component of a liquid level sensor for an electrically conductive liquid, and a second end opposite the first end, wherein the electrode is formed of one or more non-metallic materials of which at least one is an electrically conductive non-metal that is in electrically conductive contact with the first end of the electrode, and wherein at least one electrically conductive non-metal is configured for an electrically conductive contact with an electrically conductive liquid.

A liquid level sensor meeting the above demand comprises an electrode according to the above and an electric and/or electronic circuit electrically connected to said electrode and adapted to provide a first output signal indicating a contact state between the electrode and the electrically conductive liquid.

It should be noted in this context that the terms “including”, “comprising”, “containing”, “having” and “with”, as well as grammatical modifications thereof used in this specification or the claims for listing features, are generally to be considered to specify a non-exhaustive listing of features such as method steps, components, devices, ranges, dimensions or the like, and do by no means preclude the presence or addition of one or more other features or groups of other or additional features. Further, it should be noted that the terms “conductive” and “conductible” are used in this specification interchangeably for indicating a material property providing a good or, for the respective purpose, sufficient electrical conductivity.

The present invention provides a lead-free, chemically resistant electrode enabling a determination of a filling level of an electrically conductive liquid in a container without risk of contaminating the liquid.

Since non-metallic electrode materials provide high chemical resistance with respect to corrosive environments, electrodes composed of such materials have a long service life, even in chemically challenging environments, and also conform to legislative measures restricting the use of lead in electric and electronic appliances. Non-metallic electrode material electrodes for sensors enabling a determination or monitoring of a fill level of an electrically conductive liquid may for instance be used for monitoring or controlling the electrolyte level in lead-acid batteries.

Preferred configurations of electrodes as specified above comprise at least one electrical insulator with a surface extending from the first end of the electrode to the second end of the electrode, whereby the electrically conductive non-metal covers at least a part of said surface contiguously. Respective configurations enable a design of mechanically resistant and, if need be, flexible or resilient electrode support structures with an electrically conductive lining on a surface designed for providing the area for electrically contacting a liquid.

Other preferred configurations of electrodes as specified above comprise at least one electrical non-metal conductor with a surface extending from the first end of the electrode to the second end of the electrode, whereby the insulator covers at least a part of said surface contiguously.

Advantageous embodiments of the above electrodes may have a configuration, where the electrical insulator forms a hollow body with at least an opening at the second end of the electrode and with the electrically conductive non-metal being arranged on the internal surface of the hollow body or filling the void of the hollow body at least in part. Respective configurations allow a design of electrodes in which the electrically conductive part is protected from mechanical impacts or other detrimental influences from the surroundings of the electrode. Examples of such configurations may include a solid graphite electrode core cladded by a rigid electrically insulating support material.

Embodiments have the electrically conductive non-metal arranged on the inner surface of a tubular electrical insulator. For particular applications, advantageous embodiments of the previously discussed electrodes may alternatively have the electrically conductive non-metal arranged on the outer surface of the electrical insulator, ensuring a reliable wetting of the electrodes' electrically conductive part.

In an advantageous configuration of the above embodiments, the electrical insulator provides the second end of the electrode with the electrically conductive non-metal being spaced from said end allowing the second end of the electrode being immersed into the liquid while the liquid's limit or nominal level is at a determined distance above the electrode's second end. A respective configuration is particularly useful when the limit level of the liquid is defined relative to an object to be covered by the liquid.

In particularly preferred configurations of the above embodiments, the electrode has a rod-like, tubular or tongue-like shape. All shapes allow the electrode to be cut to the appropriate length on the spot. Rod-like shaped electrodes are easy to manufacture, whereby, when made using an electrically insulating material, the electrically conductive non-metal may be provided at the side and/or bottom area of a rod-shaped insulator. Tubular electrodes allow making use of capillary action drawing the liquid into the tube to achieve a bigger surface of contact between the liquid and the electrically conductive part of the electrode at the tube's inner wall. Tongue-like electrodes are preferred when a large contacting surface is required. They can be solid or have a cavity opening to the second end of the electrode.

In configurations of the above embodiments, the electrically conductive non-metal is selected from graphite, carbon fibre filaments, carbon fibre fabrics, electrically conductive resin, intrinsically conducting polymers and combinations thereof. Graphite may either be used in solid form or as a coating on a surface of an electrically insulating electrode support structure. Carbon fibre filaments may be wound around an electrically insulating electrode support structure either onto an outer or an inner surface, whereby the filaments may in the latter case first be wound around a mandrel before being transferred to an inner surface of a hollow body type insulator structure. Carbon fibre fabrics can be applied similarly to carbon fibre filaments or, when provided in hosiery form, simply pulled over the insulating electrode support structure or mandrel.

Particularly advantageous embodiments of an above electrode have the electrically conductive non-metal being a composite formed of carbon fibre filaments and/or carbon fibre fabrics in combination with an electrically conductive resin forming bonds between the carbon fibres and/or embedding the carbon fibres and/or, were appropriate, bonding the carbon fibres onto the electrical insulator. A respective composite provides a mechanically robust attachment of the carbon fibres on a support structure while ensuring the fibres to be in electrical contact with each other and an electrically conductive liquid touching a surface of the composite. In embodiments hereof, the electrically conductive non-metal is a composite formed of carbon fibre filaments and/or carbon fibre fabrics in combination with a resin, which can also be a conductive resin. In preferred configurations of respective embodiments, the electrically conductive resin composite is an epoxy resin containing graphite particles and/or carbon nanotubes or any other electrically conductive resin. The content of the graphite particles and/or carbon nanotubes in the conductive epoxy resin may be up to 80 percent of the total mass of the conductive resin allowing the particles and/or tubes to be in contact with each other.

In advantageous configurations of the above embodiments, the electrical insulator has a surface subjected to corona treatment for improving the wettability of said surface. A respective surface treatment allows to effect and/or improve the capillary action into the cavity of a hollow body electrode. Apart from the electrically insulating material, corona treatment may also be used to improve the wettability of the electrically conductive non-metal material, particularly when an electrically conductive resin or an intrinsically conducting polymer are used. Alternatively or additionally, a surface of the electrically insulating element of the electrode may be lined with a braided, woven or non-woven fabric providing a wicking capillary action for wetting the surface.

Preferred configurations of a liquid level sensor as specified above have the electric and/or electronic circuit further configured to provide a second output signal indicating a state of no electric contact being present between the electrode and the electrically conductive liquid. A respective configuration allows to discern between a contact state, a non-contact state, and a failure state, where no output signal is provided.

Embodiments of an above liquid level sensor may further also comprise a light indicator configured to emit a constant light of a first colour upon the electric and/or electronic circuit providing the first output signal with the option of a second constant light of a second colour or flashing light of the first or the second colour upon the electric and/or electronic circuit providing the second output signal. Respective embodiments or configurations provide a reliable and easy to understand optical indication of the sensor electrode contacting the electrically conductive liquid or not.

For supplying the electric and/or electronic circuit with electric energy, embodiments of the liquid level sensor may further also comprise either one or two supply wires allowing the electric and/or electronic circuit to be connected to the terminals of a battery on which the liquid level sensor is installed and/or an powered by internal source such as a battery.

In some embodiments of a sensor according to one of the above liquid level sensors, the sensor electrode is integrated or adapted to be integrated into the housing of a liquid refilling device with the length of the electrically conductive non-metal of the electrode corresponding to a limit level for the liquid in the liquid refilling device. The limit level may be the allowable maximum or minimum limit level for the liquid in the device.

Embodiments of an above liquid level sensor have the sensor's electrical insulator formed integrally with a component of the container containing the electrically conductive liquid, i.e. the sensor's electrical insulator and the container component are formed in one piece. The container component may in some embodiments be the lid of the container or a plug closing the container and allowing it to be filled and refilled.

Embodiments of an above liquid level sensor may further comprise an electrode, with two or more electrically conductive non-metal elements and with the length of the electrically conductive non-metal of at least one of the elements being equal to or shorter than the length of the electrically conductive non-metal of another of the elements. Respective electrodes provide a greater fail safety and/or a monitoring of different filling levels with one electrode.

Embodiments of an above liquid level sensor may further comprise more than one electrodes, with the length of the electrically conductive non-metal of at least one of the electrodes being shorter than the length of the electrically conductive non-metal of another one of the electrodes to allow for a monitoring of the electrically conductive liquid at different filling levels. In particular embodiments the liquid level sensor comprises two such electrodes for allowing to monitor, if a filling level is between a minimum level and a maximum level.

Configurations of the above liquid level sensors have the electronic circuit configured to transmit a signal corresponding to the first and/or second output signal to an external indication device. The transmission can be implemented wireless or wired using electrical or optical signals. Respective sensors allow to communicate the contact state of the sensor's electrode to a monitoring device which can be easy accessed by maintenance people or even to a central monitoring device displaying the contact states of several liquid level sensors.

### BRIEF DESCRIPTION OF THE DRAWINGS

Further features of the invention are obvious from the following description of exemplary embodiments together with the claims and the enclosed Figures. In the Figures, functionally and/or structurally equivalent components are, as far as possible, assigned identical or similar reference signs and numerals. It is noted that the invention is defined by the scope of the claims enclosed and is not limited to the configurations of the exemplary embodiments described herein. Other embodiments of the present invention may implement individual features in different combinations than the examples described below. In the following description of exemplary embodiments, reference is made to the enclosed Figures, of which

FIG. 1 is a schematic cross-sectional view illustrating an example of a lead-acid battery cell with a prior art liquid level sensor;

FIG. 2 is a schematic cross-sectional view of an electrode for a liquid level sensor according to a first exemplary embodiment;

FIG. 3 is a schematic perspective view of an electrode for a liquid level sensor according to a second exemplary embodiment;

FIG. 4 is a schematic cross-sectional view of an electrode for a liquid level sensor according to a third exemplary embodiment;

FIG. 5 is a schematic cross-sectional view for illustrating an electrode for a liquid level sensor according to a fourth exemplary embodiment; and

FIG. 6 is a schematic cross-sectional view for illustrating an electrode for a liquid level sensor with more than one non-metallic conductors.

It is generally to be understood that the Figures show only those components that are necessary for the understanding of the illustrated embodiments. Components necessary for the operation of the respective embodiments but not necessary for the understanding of the invention have been omitted from the Figures for the sake of clarity. Nevertheless these components are deemed to be present in an actual implementation of the respective embodiments.

### DETAILED DESCRIPTION

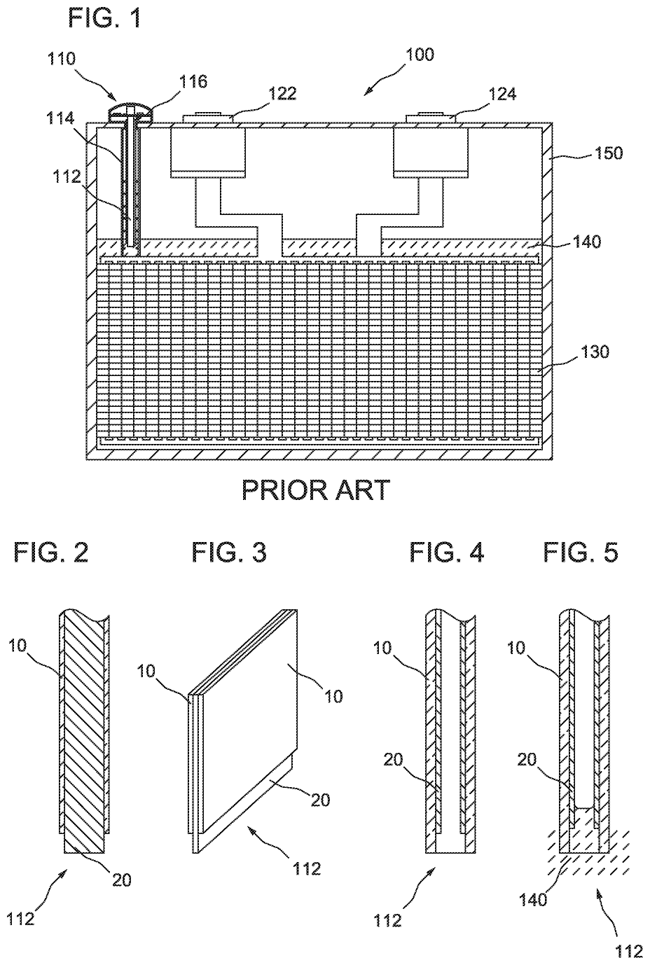

FIG. 1 shows a schematic cross-sectional view illustrating an example for lead-acid battery cell 100 equipped with a prior art liquid level sensor 110. The lead-acid battery cell 100 comprises a housing 150 acting as container for the electrolyte 140 and the two plates 130 of lead serving as positive and negative electrodes respectively. Each plate 130 of lead is electrically and mechanically connected to a respective terminal 122 or 124 providing electrical contact to the outside. A liquid level sensor 110 is mounted to the housing 150 with its electrode 112 penetrating through the housing 150. The upper first end of the electrode 112 is electrically connected to a component of an electric circuit or an electronic circuit or a combination of both. In the example shown, the first end of the electrode 112 is connected to a terminal of an electronic evaluation circuit. Laid open patent application DE 10 2007 004 693 A1 discloses an example for a respective evaluation circuit. For operation, the liquid level sensor 110 is provided with two supply wires (not shown) allowing it to be connected to the terminals of a battery formed by interconnecting several cells 100. The length of the electrode 112 is chosen such that the second free end of the electrode, i.e., the end of the electrode opposite of the first end of the electrode, is disposed at a certain distance above the plates of lead 122 and 124. The distance corresponds to the minimum level of the electrolyte 140 above plates of lead 122 and 124 required to ensure a proper operation of the battery. As will be appreciated by a person skilled in the art, the terms “above” and “below” are to be understood with respect to the direction of gravity. The electrode 112 is frequently surrounded by a gauge guard 114 that retains the electrode 112 and props it against the upper side of the plate of lead. The gauge guard comprises several openings allowing the electrolyte not only to enter the interior of the gauge guard through its open bottom but also through its sides. Due to confining the space around and below the electrode, the gauge guard slows down level fluctuations in the vicinity of the electrode 112 that may be caused by, e.g., a tilting of the battery cell 100. As already explained above, an electrode 112 according to the prior art is preferably made from a lead rod that is in many applications cladded with a plastic coating so that only the tip at the second end of the electrode is exposed. The coating avoids incorrect measurements caused by condensate adhering to the side of the electrode 112.

The schematic cross-sectional view of FIG. 2 illustrates an electrode 112 for a liquid level sensor according to a first exemplary embodiment. The electrode shown in the Figure is basically configured of two components: a rod-shaped core 20 made of an electrically conducting non-metallic material, and an electrically insulating material 10 disposed around the side surface of the core 20 in the form of a sheathing. In preferred embodiments, such as the one illustrated in FIG. 2, the electrically insulating sheathing 10 does not cover the whole side surface but leaves a tip portion of the core 20 exposed. The bottom end of the electrode, at its tip portion, forms the second end of the electrode. The upper first end of the electrode 112 is not shown in FIG. 2. It is, however, present and electrically connected to a component of an electric and/or electronic circuit disposed in the sensor head located outside the battery cell's housing. The electrical connection between the circuit component and the first end of the electrode is implemented by an electrically conductive connection formed between the electrically conductive core 20 in a region at or near the first end of the electrode 112 and the component. The connection may be a clamped or crimp connection. Other configurations may use a pin or spike penetrating the core 20.

The distance between the lower end of the electrically insulating sheathing 10 and the second end of the electrode, i.e., the lower end of the electrically conductive non-metallic core 20, is preferably chosen to correspond to the distance between the minimum level of the electrolyte and the upper side of the plates 130 of lead. This allows the electrode 112 to be propped against the plates of lead, thereby providing a precise determination of the minimum level of the electrolyte.

In some embodiments, the electrode may instead be formed of an electrically conductive non-metal 20 only, whereby the non-metal has a rod-shaped, a tube-shaped, a plate-shaped or any other suitable form.

Appropriate values for the electrical conductivity are achieved when using graphite, carbon fibre filaments or carbon fibre fabrics as electrically conductive non-metal. Other materials suited to form a respective electrically conductive non-metal sheathing are conductive resin, that is, in the context of the present invention a resin-filler composite, where the filler is an electrically conductive non-metal, as well as intrinsically conducting polymers. In particular embodiments, the electrically conductive resin is an epoxy resin containing graphite particles and/or carbon nanotubes. The content of the filler particles in the conductive resin may be up to 80 percent of the total mass of the conductive resin allowing the particles and/or tubes to contact each other, thereby ensuring an electrical contact between them.

The electrically insulating sheathing 10 may be a solid material filling the whole space, it may, however, also be configured to cover the sheathed surface continuously but only in part, for instance having a mesh-like structure.

It is noted that the electrical insulator 10 may also be hollow like a tube or a tube with one or both ends sealed.

The perspective view of FIG. 3 illustrates a second exemplary embodiment providing a possible alternative to a rod-shaped electrode 112. The electrode 112 shown in FIG. 3 has a plate-shaped or tongue-shaped structure. The electrode 112 has a sandwich configuration, where the plate-shaped electrical non-metal conductor 20 is sandwiched between two layers of an electrical insulator 10. In this embodiment also, the electrically insulating plates do not extend down to the lower, i.e., second end of the electrode. Different to that the electrical non-metallic conductor is completely sandwiched between the two layers of the electrical insulator 10 at the upper first end. Other configurations have the conductive non-metal also disposed around the front ends of the electrode 112.

To slow down level fluctuations in the vicinity of the electrode 112, the electrode may further be mounted in a gauge guard similar to that described above with reference to FIG. 1.

As an example, graphite, as the non-metallic conductor 20, may be deposited on the surface of an insulating medium 10. To improve adhesion, the insulator 10 may be corona treated before the graphite is applied. Alternatively, the surface of the insulator 10 can be pre-treated chemically or mechanically.

In another example, carbon fibre filaments are wound around the inner surface of the tubular insulating core 10 except for the area to be exposed at the second end of electrode 112. An epoxy resin can be used to fix the fibres to the surface of the core, whereby the epoxy is applied to the surface of the core 10 before the carbon fibre filaments are wound up. Alternatively, the carbon fibre filaments can be wound around the entire side surface of the insulating core, whereby the region of the core at the lower end of the electrode not to be covered by the sheathing is subsequently exposed by material removal.

In another example, the sheathing 10 consists of an electrically insulating resin as described above, which can be applied to the side surface of the electrically non-metallic conductive core 20 by dipping, rolling, or in the form of prefabricated prepregs. All electrically insulating fillers that have no solubility in the electrolyte can be used. Graphite particles such as graphite platelets and carbon nanotubes are especially preferred. Graphene may also be used.

In another example, the sheath 20 can be formed from an intrinsically conductive polymer.

The fibre filaments or fibre fabrics can also be impregnated beforehand with an electrically insulating resin or overmoulded with a thermoplastic polymer resin. The electrically conductive carbon fibres thus form bonds between the carbon fibres and/or even embeds the carbon fibres thereby providing a strengthening of the structural integrity of the sheathing 10. The end or ends of the carbon fibre(s) can be left exposed, so they would act as a non-metallic electrical conductor 20, when making contact with the liquid or electrolyte 140.

The schematic cross-sectional view of FIG. 4 illustrates an electrode 112 for a liquid level sensor according to a third exemplary embodiment. The electrode is basically comprised of a tubular electrical insulator element 10 and a tubular electrically conductive non-metal element 20 lining the inside surface of the tubular electrical insulator element 10 except for a region at the second end of the electrode. It is understood, that the above expression “basically comprised of” is used to indicate the essential elements only and does not further exclude a presence of other elements.

The electrically conductive element 20 may be formed by placing carbon fibres on a mandrel followed by inserting the mandrel into the space inside the tubular insulator 10 and transferring the fibres onto the internal surface of the insulator element 10. This may be achieved by using an expandable mandrel and/or a winding technique allowing the diameter of the fibre windings to be increased after insertion, e.g., by compressing the windings axially. In embodiments, the axial length of the region at the second end of the electrode 112 not covered by the electrically insulating element 10 is selected to correspond to the required minimum level of the electrolyte 140 above the second end of the electrode 112 when in use. In this case, the part of the insulator element 10 between the second end of electrode 112 and the lower end of the electrically conductive element 20 may preferably be provided with at least one opening (not shown) in its side wall, e.g., a hole or a slit, for enabling a better access of the liquid 140 into the interior of the electrode. Fixing of the tubular insulator 10 on the electrically conductive element 20 can be achieved by a suitable adhesive or by an epoxy resin arranged between the two, or other suitable means of bonding the two surfaces together.

Similar to the described above, the tubular electrically conductive non-metal element 20 may also be formed by vaporizing graphite onto the internal surface of the electrically insulating element 10. When using an intrinsically conducting polymer for the tubular electrically conductive non-metal element 20, the element 20 may be overmoulded with the tubular electrically insulating element 10 to form the electrode 112. The latter method may also generally be used when the tubular electrically conductive non-metal element 20 is made in advance, e.g., from carbon fibres embedded within a resin.

As with the other embodiments described referencing FIGS. 2 and 3, an electrically insulating coating may be applied to the inside surface of the tubular electrically conductive non-metal element 20 to prevent incorrect measurements caused by condensate. The coating preferably leaves a lower region of the element 20 exposed to ensure an area large enough for reliably contacting an electrically conductive liquid.

In alternative embodiments a rod-like electrically conductive non-metal element 20 is placed inside the electrically insulating element 10 to form an electrode 112. In preferred configurations of such an electrode, the element 20 is a solid graphite rod, or of other suitable materials, such as carbon fibres.

The schematic cross-sectional view of FIG. 5 illustrates an electrode 112 for a liquid level sensor 110 according to a fourth exemplary embodiment. The fourth exemplary embodiment differs from the third exemplary embodiment shown in FIG. 4 by the interior surface(s) of the tubular electrode 112 being modified by corona treatment. Corona treatment uses a low temperature corona discharge plasma to impart changes in the properties of a surface.

The corona treatment is used to improve the wettability of the surface(s). It can be used in the manufacturing process for improving the adhesion between the different elements of the electrode 112, but also for improving the wetting of the electrode with the liquid 140. Wettable surfaces in tubular bodies enable a capillary action, particularly a capillary rise, enabling a drawing of a part of the liquid into the inside of the tubular electrode 112 as illustrated in FIG. 5. A respective capillary rise results in a larger surface wetted by the liquid in the interior of the electrode 112 and thus a more reliable detection of a liquid level. Alternatively or additionally, a surface of the inside of the hollow tubular electrically insulating element 10 of the electrode 112 may be lined with a braided, woven or non-woven fabric providing a wicking capillary action for wetting the surface.

In some embodiments, the electrical insulator 10 of the liquid level sensor is formed in one piece, i.e. integrally, with a component of the container 150 containing the electrically conductive liquid 130, for example with the lid of the container or a plug closing the container and allowing it to be filled and refilled.

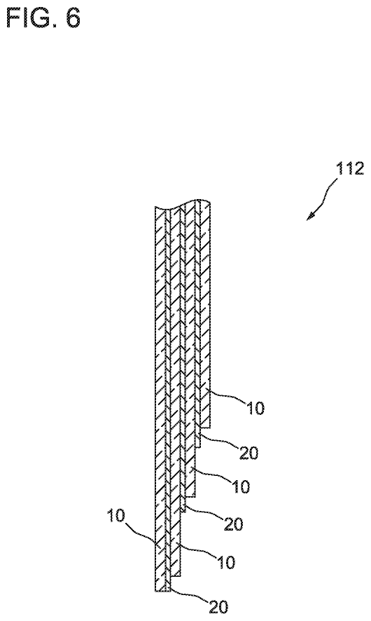

Embodiments of an above liquid level sensor may further comprise one electrode with two or more non-metal conductive elements, and with the length of one of the electrically conductive non-metal components being equal to or different to the length of another one of the electrically conductive non-metal components of the electrode to enable a monitoring of a filling level between a minimum level and a maximum level or at different filling levels, as illustrated in FIG. 6.

An above single electrode or multiple electrode liquid level sensor may not only be used with a container to be refilled such as a lead acid battery, but also with a liquid refilling device like for instance a container of a refilling unit containing liquid stock used to refill other devices.

While the present invention has been shown and described herein in what is believed to be the most practical and preferred embodiments, it is recognised that many alternatives, modifications, and variations thereof will be apparent to those skilled in the art. Accordingly, the exemplary embodiments of the invention set forth herein are intended to be illustrative only and not limiting in any way. Various changes may be made without departing from the spirit and scope of the present invention as defined in the following claims.

What is claimed is:

1. An electrode for a liquid level sensor adapted for a determination of a liquid level of an electrically conductive liquid in a container, the electrode comprising:
a first end configured for an electrically conductive contact with a sensor component of the liquid level sensor;
a second end opposite the first end; and
wherein the electrode is formed of one or more non-metallic materials of which at least one is an electrically conductive non-metal that is in electrically conductive contact with the first end of the electrode, and wherein the at least one electrically conductive non-metal is configured for an electrically conductive contact with the electrically conductive liquid.

2. The electrode of claim 1, wherein the electrode comprises at least one electrically conductive non-metal with a surface extending from the first end of the electrode to the second end of the electrode, and wherein an electrical insulator covers at least a part of said surface contiguously.

3. The electrode of claim 2, wherein the electrical insulator forms a hollow body with at least an opening at the second end of the electrode and with the electrically conductive non-metal being arranged on the internal surface of the hollow body or filling the void of the hollow body at least in part.

4. The electrode of claim 2, wherein the electrically conductive non-metal is arranged on the inner surface of the tubular electrical insulator.

5. The electrode of claim 3, wherein the electrical insulator provides the second end of the electrode with the electrically conductive non-metal being spaced from said end.

6. The electrode of claim 1, wherein the electrode is rod shaped, tubular shaped, or tongue shaped.

7. The electrode of claim 1, wherein the electrically conductive non-metal is selected from graphite, carbon fibre filaments, carbon fibre fabrics, electrically conductive resin, intrinsically conducting polymers, and combinations thereof.

8. The electrode of claim 7, wherein the electrically conductive non-metal is a composite formed of carbon fibre filaments and/or carbon fibre fabrics in combination with a resin.

9. The electrode of claim 8, wherein the composite is an epoxy resin containing graphite particles, carbon nanotubes, or any other electrically conductive resin.

10. The electrode of claim 7, wherein the electrode comprises at least one electrically conductive non-metal with a surface extending from the first end of the electrode to the second end of the electrode, wherein an electrical insulator covers at least a part of said surface contiguously, wherein the electrical insulator forms a hollow body with at least an opening at the second end of the electrode and with the electrically conductive non-metal being arranged on the internal surface of the hollow body or filling the void of the hollow body at least in part, and wherein the electrical insulator and/or the electrically conductive non-metal have a surface subjected to corona treatment for improving the wettability of said surface and/or are lined with a braided, woven or non-woven fabric providing a wicking capillary action.

11. A liquid level sensor, comprising:
an electrode comprising a first end configured for an electrically conductive contact with a sensor component of the liquid level sensor, a second end opposite the first end, wherein the electrode is formed of one or more non-metallic materials of which at least one is an electrically conductive non-metal that is in electrically conductive contact with the first end of the electrode, and wherein the at least one electrically conductive non-metal is configured for an electrically conductive contact with the electrically conductive liquid; and
a circuit electrically connected to said electrode and adapted to provide a first output signal indicating a contact state between the electrode and the electrically conductive liquid.

12. The liquid level sensor of claim 11, wherein the circuit is further configured to provide a second output signal indicating a state of no electric contact being present between the electrode and the electrically conductive liquid.

13. The liquid level sensor of claim 11, further comprising a light indicator configured to emit a constant light of a first colour upon the circuit providing the first output signal with the option of a second constant light of a second colour or flashing light of the first or the second colour upon the circuit providing the second output signal.

14. The liquid level sensor of claim 11, wherein the sensor electrode is formed integrally with a component of the container.

15. The liquid level sensor of claim 11, further comprising either one and/or two supply wires allowing the circuit to be connected to the terminals of a battery on which the liquid level sensor is installed and/or powered by an internal source.

16. The liquid level sensor of claim 11, wherein the electrode comprises two or more conductive non-metal elements and with the length of the electrically conductive non-metal of at least one of the elements being equal to or shorter than the length of the electrically conductive non-metal of another one of the elements.

17. The liquid level sensor of claim 11, wherein the sensor is integrated into the housing of a liquid refilling device with the length of the electrically conductive non-metal of the electrode corresponding to a limit level for the liquid in the liquid refilling device.

18. The liquid level sensor of claim 11, wherein the circuit is configured to transmit a signal corresponding to the first and/or second output signal to an external indication device.
